(19) United States
(12) Patent Application Publication
(10) Pub. No.: US 2026/0010309 A1
(43) Pub. Date: Jan. 8, 2026

(54) INFORMATION PROCESSING SYSTEM AND CONTROL METHOD

(71) Applicant: Hitachi Vantara, Ltd., Yokohama-shi (JP)

(72) Inventors: Masataka KOMIYA, Yokohama-shi (JP); Hiromichi OTA, Yokohama-shi (JP)

(73) Assignee: Hitachi Vantara, Ltd., Yokohama-shi (JP)

(21) Appl. No.: 19/076,436

(22) Filed: Mar. 11, 2025

(30) Foreign Application Priority Data
Jul. 2, 2024 (JP) 2024-106956

(51) Int. Cl. G06F 3/06; H04L 43/50

(52) U.S. Cl. CPC G06F 3/065; G06F 3/0665; G06F 3/067; H04L 43/50

(57) ABSTRACT

An information processing system includes a plurality of primary-side storage systems, one or more secondary-side storage systems configured to copy data of the plurality of primary-side storage systems, and one or more hosts configured to control input/output (I/O) of the plurality of primary-side storage systems. Each of the plurality of primary-side storage systems includes a storage controller configured to control I/O, and a management module configured to transmit, to the storage controller, test packets, at a transmission cycle set by a user. The storage controller is configured to receive the test packets transmitted from the management module, and count the number of packets received by the storage controller. The management module is configured to acquire, from the storage controller, the number of received packets, evaluate the transmission cycle based on the number of received packets, and present, to the user, a result of the evaluation.

### BACKGROUND OF THE INVENTION

### 1. Field of the Invention

The present invention relates to an information processing system and a control method.

### 2. Description of the Related Art

In a storage system, asynchronous remote copy is known in which data is asynchronously copied from a primary-side storage to a secondary-side storage using a journal.

As a technique for asynchronous remote copy, JP 2004-252686 A describes that a control unit of a storage device system copies data stored in a first storage device to a second storage device on the basis of a predetermined instruction, stores, upon receiving a request to update the data stored in the first storage device after the predetermined instruction is issued, update content of the data, in a third storage device, as an update history, and records, when predetermined identification information is transmitted from a computer after the predetermined instruction is issued, the predetermined identification information in association with the update history. With this technique, by using the identification information issued as an instruction by the computer and the identification information stored in the third storage device, the storage device performs a high-speed restoration to restore a state of data included in the storage device at a time point intended by the computer.

It is also known to create a data copy between a plurality of primary-side storages and a plurality of secondary-side storages.

JP 2010-102463 A describes that each primary storage system writes, in response to a write command from an I/O issuing unit, write-target data to a primary volume, creates a journal including journal data that is a copy of the write-target data and a latest ID received from a storage management unit, stores the created journal in a primary journal storage area, and transfers the journal to a connection-destination secondary storage system. The secondary storage system writes the received journal to a secondary journal storage area, and reflects, in a secondary volume, up to a journal having an ID one older than the oldest ID among one or more unreflected journals stored in the secondary journal storage area. As a result, even if a time stamp is not given to the write-target data received by the primary storage system, the consistency of the data stored in the secondary storage system can be maintained.

In asynchronous remote copy, since I/O processing for a primary volume is completed without waiting for completion of I/O processing for a secondary volume, data of the primary volume and data of the secondary volume may fail to match each other. Therefore, in order to guarantee consistency in data between the primary volume and the secondary volume, journal volumes belonging to respective storages are collectively managed. Specifically, arbitration for periodically acquiring a data section is performed.

Here, the “arbitration” is performed as follows. Management software installed in a server transmits an arbitration instruction to all the storages to be managed at a predetermined transmission cycle, causes all the primary-side storages to be in a state of stopping I/O acceptance, and transmits serial number information to the primary-side storages. In each primary-side storage, the serial number information transmitted from the management software is written to a journal, and I/O acceptance is resumed. When restoration is performed after the arbitration, data is held up to data to which the serial number information has been written, and subsequent data is deleted.

### SUMMARY OF THE INVENTION

In performing arbitration, fiber channel small computer system interface (FC-SCSI) communication, which is one of the standards of fiber channel communication, is used for an arbitration instruction to a primary-side storage. However, since an optical fiber as a communication infrastructure therefor is expensive, there is a demand for use of user datagram protocol (UDP) communication via Ethernet that becomes currently mainstream and with which a communication infrastructure becomes inexpensive.

However, the UDP communication has communication stability lower than that of the FC-SCSI communication. Therefore, in the UDP communication, there is a case in which arbitration may fail due to a phenomenon in which an arbitration instruction from management software to the primary-side storage is not transmitted within a predetermined time period. When restoration is performed after the arbitration fails, an amount of deleted data increases.

Further, in a case where a FC-SCSI protocol is used for arbitration processing, communication processing for the arbitration instruction is executed in a main CPU of the primary-side storage, similarly to normal I/O processing with the FC-SCSI protocol. On the other hand, in a case where a UDP protocol is used for the arbitration processing, an additional processing for transmitting and receiving a UDP packet of the arbitration instruction is required in the main CPU of the primary-side storage, in addition to the normal I/O processing with the FC-SCSI protocol. Therefore, the load on the main CPU of the primary-side storage increases.

Thus, it is required to set the transmission cycle of the arbitration instruction to an appropriate value. However, there seems to be no description about the setting of the transmission cycle of the arbitration instruction to an appropriate value, in JP 2004-252686 A and JP 2010-102463 A.

Therefore, it is an object of the present invention to provide a technique capable of providing a user with information for setting a transmission cycle of an arbitration instruction to an appropriate value.

In order to solve the above problems, an information processing system according to the present invention is an information processing system including: a plurality of primary-side storage systems; one or more secondary-side storage systems configured to copy data of the plurality of primary-side storage systems; and one or more hosts configured to control input/output (I/O) of the plurality of primary-side storage systems, in which each of the plurality of primary-side storage systems includes: a control unit configured to control I/O; and a management unit configured to transmit, to the control unit, test packets, at a transmission cycle set by a user, the control unit is configured to receive the test packets transmitted from the management unit, and count a number of received packets, and the management unit is configured to: acquire, from the control unit, the number of received packets; perform evaluating the transmission cycle based on the number of received packets; and present, to the user, a result of the evaluating.

According to the present invention, it is possible to provide a user with information for setting a transmission cycle of an arbitration instruction to an appropriate value.

### BRIEF DESCRIPTION OF THE DRAWINGS

FIG. 1 is a block diagram illustrating a configuration example of an information processing system of the present embodiment;

FIG. 2 is a block diagram illustrating an example of a hardware configuration of a primary-side storage system;

FIG. 3 is a block diagram illustrating an example of a hardware configuration of the primary-side storage system;

FIG. 4 is a diagram for explaining an example of an operation of the information processing system of the present embodiment;

FIG. 5A is a diagram illustrating an example of a setting information storage table;

FIG. 5B is a diagram illustrating an example of a management table;

FIG. 6 is a flowchart illustrating an example of arbitration setting processing;

FIG. 7 is a diagram illustrating an example of an arbitration setting screen;

FIG. 8 is a flowchart illustrating an example of a setting value validity test;

FIG. 9 is a flowchart illustrating an example of arbitration operation monitoring processing;

FIG. 10 is a flowchart illustrating an example of an in-operation validity check;

FIG. 11 is a flowchart illustrating an example of packet dequeuing frequency change processing;

FIG. 12 is a flowchart illustrating an example of packet dequeuing frequency change processing;

FIG. 13 is a diagram illustrating an example of an arbitration monitoring screen;

FIG. 14A is a diagram illustrating an example of an alert display screen; and

FIG. 14B is a diagram illustrating an example of an alert detail display screen.

### DESCRIPTION OF THE PREFERRED EMBODIMENT

Hereinafter, an embodiment will be described with reference to the drawings.

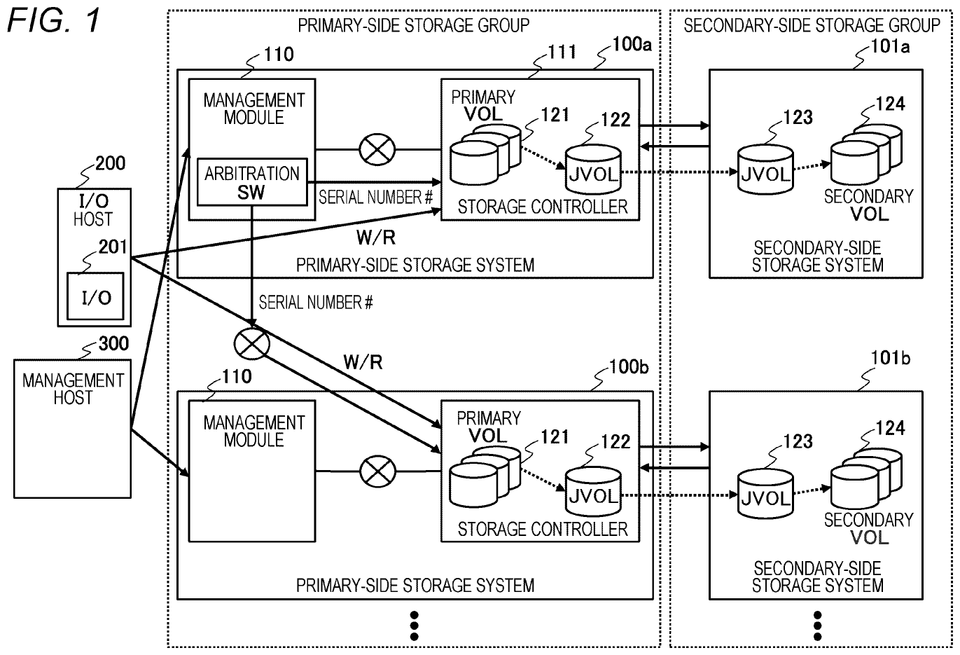

A configuration of an information processing system of the present embodiment will be described with reference to FIGS. 1 to 4.

FIG. 1 is a block diagram illustrating a configuration example of the information processing system of the present embodiment.

The information processing system includes a plurality of primary-side storage systems 100 belonging to a primary-side storage group, a plurality of secondary-side storage systems 101 belonging to a secondary-side storage group, an I/O host 200, and a management host 300.

The I/O host 200 is a computer such as a personal computer, a workstation, or a mainframe. In the I/O host 200, an operating system (hereinafter referred to as “OS”) suitable for a type of the computer is operated, while application programs (APs) suitable for various tasks and uses, such as a database program and the like, are operated. The I/O host 200 is connected to the primary-side storage systems 100 via a storage area network (SAN).

The I/O host 200 includes an I/O issuing unit 201. The I/O issuing unit 201 is implemented by an application program and/or an operating system (OS). The OS is an open system OS. The I/O issuing unit 201 transmits a write command or a read command to the primary-side storage systems 100 belonging to the primary-side storage group. Hereinafter, the write command and the read command each are collectively referred to as an I/O command.

The management host 300 is a computer used for managing failure, maintenance, a configuration, performance information, and the like of each of the primary-side storage systems 100. For example, the management host 300 is used in a case where an administrator of the information processing system sets a logical storage device in the primary-side storage system 100, in a case where the administrator sets a storage area for backing up data, or in a case where the administrator sets a pair of storage areas when data is copied.

The primary-side storage systems 100 and the secondary-side storage systems 101 have an M×N configuration. That is, the information processing system includes M primary-side storage systems 100 belonging to the primary-side storage group and N secondary-side storage systems 101 belonging to the secondary-side storage group.

M is an integer of one or more, and N is an integer of one or more. At least one secondary-side storage system 101 is connected to the primary-side storage system 100, and at least one primary-side storage system 100 is connected to the secondary-side storage system 101.

Therefore, for example, a configuration may be adopted in which one secondary-side storage system 101 is connected to two primary-side storage systems 100. The information processing system of the present embodiment includes two primary-side storage systems 100a, 100b and two secondary-side storage systems 101a, 101b. Then, the primary-side storage systems 100a, 100b are respectively connected to the secondary-side storage systems 101a, 101b on a one-to-one basis. That is, the primary-side storage system 100a is connected to the secondary-side storage system 101a and communicates with the secondary-side storage system 101a, and the primary-side storage system 100b is connected to the secondary-side storage system 101b and communicates with the secondary-side storage system 101b.

Each of the primary-side storage systems 100a, 100b includes a management module 110 (management unit) and a storage controller 111 (control unit).

Each of the storage controllers 111 includes primary volumes 121 and a primary journal volume 122. On the other hand, the secondary-side storage system 101a includes a secondary journal volume 123 and secondary volumes 124.

The primary volume 121 is a logical volume specified by the write command from the I/O host 200. According to the write command, write-target data is written to the primary volume 121.

The primary journal volume 122 is a logical volume to which a journal is written. The journal is information indicating an update history of the primary volume 121. The journal includes, for example, a journal group management table and journal data. The journal group management table is management information related to the journal.

The journal group management table includes, for example, a sequence number indicating an order at which a journal having this journal group management table is created, update location information indicating a primary volume 121 to which write-target data, corresponding to journal data in this journal, is written and the written location of the write-target data in this primary volume 121, and serial number information to be described later. The journal data is a copy of the write-target data.

The journal of the primary journal volume 122 is transferred to the secondary-side storage system 101, and is written to the secondary journal volume 123.

The secondary volume 124 is a logical volume forming a pair with the primary volume 121. The journal data written in the secondary journal volume 123 is written to the secondary volume 124. That is, the data stored in the primary volume 121 is also stored in the secondary volume 124.

The logical volumes including the primary volume 121, the primary journal volume 122, the secondary journal volume 123, and the secondary volume 124 are logical storage devices formed on the basis of other physical storage devices 150 such as a plurality of hard disk drives (HDDs) or flash memories included in the primary-side storage system 100 or the secondary-side storage system 101.

One of the management modules 110 in the primary-side storage group includes arbitration software. The management module 110 including the arbitration software is connected to all the primary-side storage systems 100. The arbitration software is a computer program executed by a microprocessor.

The arbitration software performs arbitration as follows to retain a data section, that is, to temporarily stop data change in a volume and retain a state in which there is no possibility of subsequent rewriting.

First, the arbitration software transmits a freeze instruction (stop instruction) to the storage controllers 111 of all the primary-side storage systems 100 at a predetermined interval, and causes all the storage controllers 111 to be in a state of stopping I/O acceptance. Next, the arbitration software issues, to all the storage controllers 111, serial number information with which the consistency of data copied to the secondary-side storage systems 101 is determined. Each storage controller 111 sets the issued serial number information in the journal group management table of a corresponding one of the primary journal volumes 122.

When the primary-side storage system 100 is restored after the arbitration, data is held up to data to which serial number information has been written, and subsequent data is deleted. Thus, the consistency of the data copied to the secondary-side storage system 101 is maintained.

In the present embodiment, the management module 110 is provided in the primary-side storage system 100. However, the management module 110 may be provided in other equipment such as the management host 300 connected to the primary-side storage system 100.

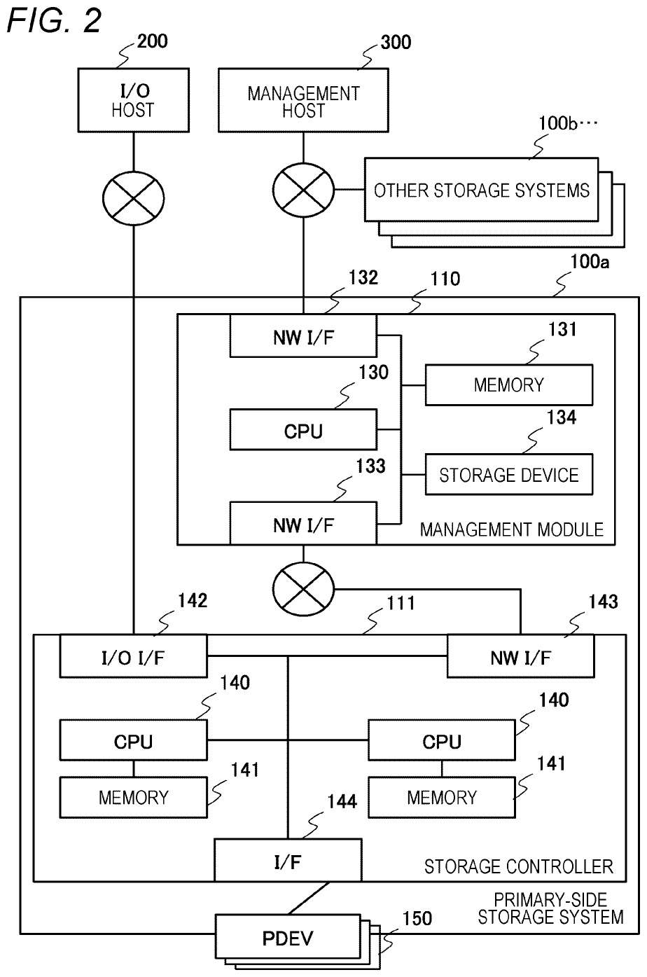

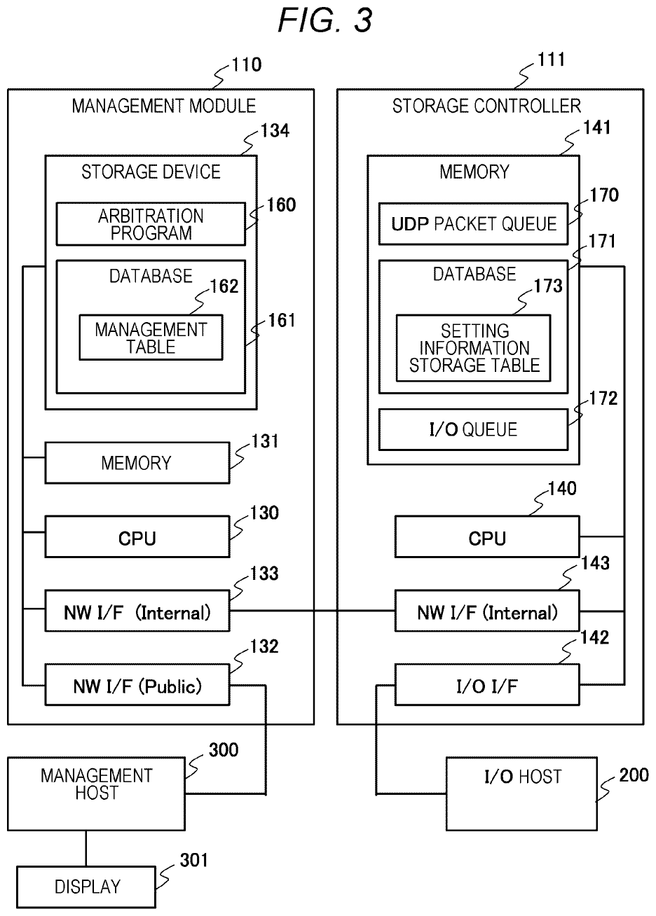

FIGS. 2 and 3 are block diagrams illustrating respective examples of respective hardware configurations of the primary-side storage system 100.

The primary-side storage system 100 includes the management module 110, the storage controller 111 connected to the management module 110 via a network, and the physical storage devices 150 connected to the storage controller 111.

The management module 110 includes a central processing unit (CPU) 130, a memory 131, a network interface 132 for communicating with the management host 300, a network interface 133 for communicating with the storage controller 111, and a storage device 134.

The CPU 130 is a central processing unit, and implements necessary functions by executing a program held in the memory 131 (or the storage device 134).

The memory 131 is a main storage device used when the CPU 130 executes processing, and includes a volatile storage element such as a random access memory (RAM).

The storage device 134 is an auxiliary storage device for storing input data to be provided to the CPU 130 and output data output from the CPU 130, and includes a non-volatile storage element such as a hard disk drive (HDD) or a solid state drive (SSD).

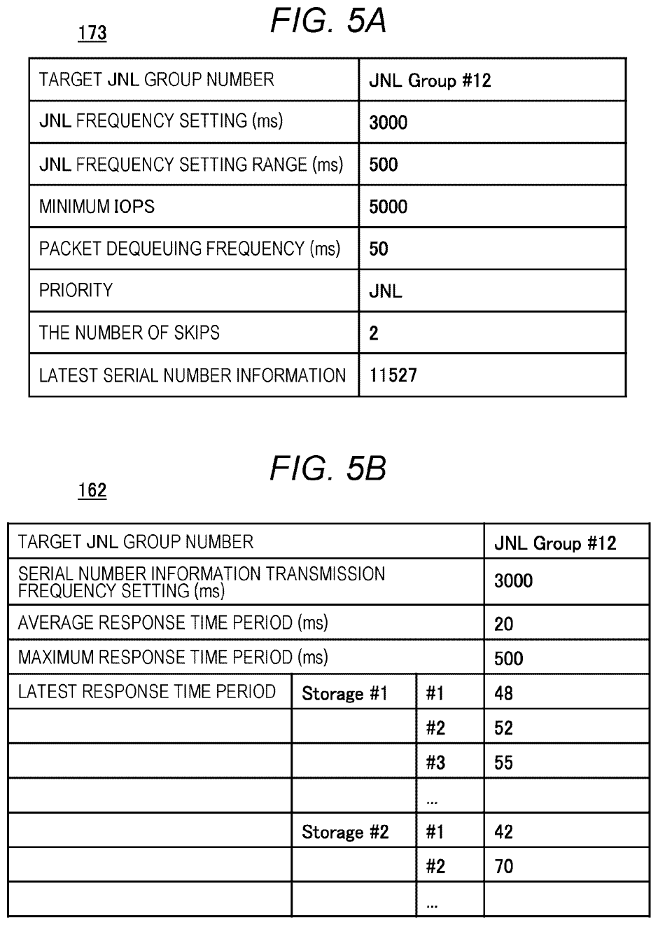

The storage device 134 stores an arbitration program 160 for implementing the arbitration software described above, and a database 161 including various types of data. The database 161 includes, for example, a management table 162 to be described later with reference to FIG. 5B. The management table 162 stores various types of setting information used for arbitration.

The storage controller 111 includes CPUs 140, memories 141, an I/O interface 142 for communicating with the I/O host 200, a network interface 143 for communicating with the management module 110, and an interface 144 for communicating with the physical storage devices 150.

The CPU 140 is a central processing unit, and implements necessary functions by executing a program (not illustrated) held in the memory 141.

The memory 141 is a main storage device used when the CPU 140 executes processing, and includes a volatile storage element such as a random access memory (RAM).

The memory 141 includes a UDP packet queue 170, a database 171 including various types of data, and an I/O queue 172.

The UDP packet queue 170 stores a UDP packet transmitted from the management module 110.

The database 171 includes, for example, a setting information storage table 173 to be described later with reference to FIG. 5A. The setting information storage table 173 stores various types of setting information used for arbitration. The setting information storage table 173 stores setting values common to the storage controllers 111 of all the primary-side storage systems 100.

The I/O queue 172 stores the write command transmitted from the I/O host 200.

The management host 300 includes a display 301.

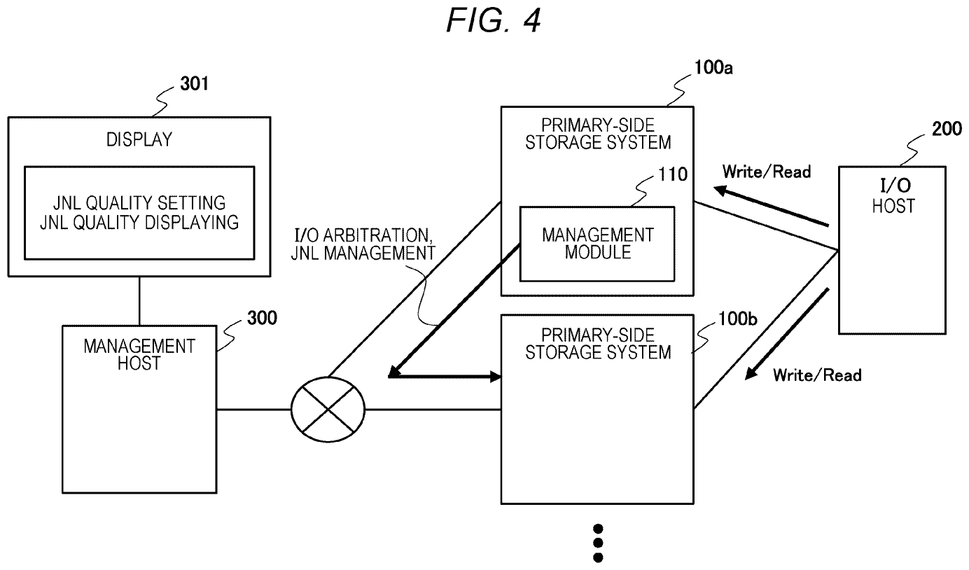

FIG. 4 is a diagram for explaining an example of an operation of the information processing system of the present embodiment.

The management host 300 manages failure, maintenance, a configuration, performance information, and the like of each primary-side storage system 100.

The I/O host 200 transmits a write command or a read command to each primary-side storage system 100.

The primary-side storage system 100 writes write-target data to the primary volume 121 according to the write command from the I/O host 200. The primary-side storage system 100 also writes, as a journal, an update history of the primary volume 121 in the primary journal volume 122.

The one primary-side storage system 100a includes the arbitration program 160 in the management module 110. The arbitration software performs arbitration as follows to retain a data section. Note that a primary-side storage system 100 that performs the arbitration may be freely selected, or may be specified in advance by a user or an administrator.

First, the arbitration software transmits a freeze instruction to the storage controllers 111 of all the primary-side storage systems 100 at a predetermined interval, causes all the storage controllers 111 to be in a state of stopping I/O acceptance, and issues serial number information to all the storage controllers 111. Each storage controller 111 sets the issued serial number information in the journal group management table of a corresponding one of the primary journal volumes 122.

When the primary-side storage system 100 is restored after the arbitration, data is held up to data to which serial number information has been written, and subsequent data is deleted.

FIG. 5A is a diagram illustrating an example of the setting information storage table 173 stored in the memory 141 of the storage controller 111.

The setting information storage table 173 includes information such as a target journal group number, a journal frequency setting, a journal frequency setting range, minimum IOPS, a packet dequeuing frequency, priority, the number of skips, and latest serial number information. In the setting information storage table 173, values are stored that are common to all the primary-side storage systems 100 belonging to the primary-side storage group.

The journal frequency setting, the journal frequency setting range, the minimum IOPS, the packet dequeuing frequency, the journal priority, and the like are set by user's input in arbitration setting processing to be described later.

The journal frequency setting is a frequency at which the management module 110 transmits a freeze instruction to the storage controller 111.

The journal frequency setting range is a value of an allowable range in the journal frequency setting value.

The minimum IOPS is a minimum value of the number of I/O accesses that can be processed in one second by the CPU 140 of the storage controller 111 of the primary-side storage system 100.

The packet dequeuing frequency is a frequency at which a check is made on a UDP packet transmitted from the management module 110 and stored in the UDP packet queue. The UDP packet also includes the freeze instruction transmitted from the management module 110 in arbitration.

The priority is information indicating which of the journal frequency setting or the IOPS is prioritized when the journal frequency setting and the packet dequeuing setting are automatically changed.

The number of skips is the number of times transmission of the serial number information is skipped from the management module 110 to the storage controller 111 due to the fact that freeze processing has been inexecutable within a predetermined time period after the management module 110 has transmitted the freeze instruction to the storage controller 111.

The latest serial number information is serial number information set last in the journal group management table.

FIG. 5B is a diagram illustrating an example of the management table 162 stored in the storage device 134 of the management module 110.

The management table 162 includes information such as the target journal group number, serial number information transmission frequency setting, an average response time period, a maximum response time period, and a latest response time period.

The serial number information transmission frequency setting is a value of a frequency at which the management module 110 transmits the serial number information to each storage controller 111. The serial number information transmission frequency setting has the same value as the journal frequency setting.

The average response time period is an average response time period from when the management module 110 transmits the freeze instruction to each storage controller 111.

The maximum response time period is a maximum response time period from when the management module 110 transmits the freeze instruction to each storage controller 111.

The latest response time period is a latest response time period of each of the storage controllers 111 of the primary-side storage systems 100.

Next, processing executed in the information processing system of the present embodiment will be described with reference to flowcharts. In the following description, for convenience, the CPUs 130, 140 that operate by executing various programs, as entities that execute control or processing in the management module 110 or the storage controller 111, may be generally referred to as a “management module” and a “storage controller”, respectively.

In the following processing, the management module 110 is a management module 110 of one of the plurality of primary-side storage systems 100 belonging to the primary-side storage group, and includes the arbitration software. In addition, the storage controllers 111 are the storage controllers 111 of all the primary-side storage systems 100 belonging to the primary-side storage group.

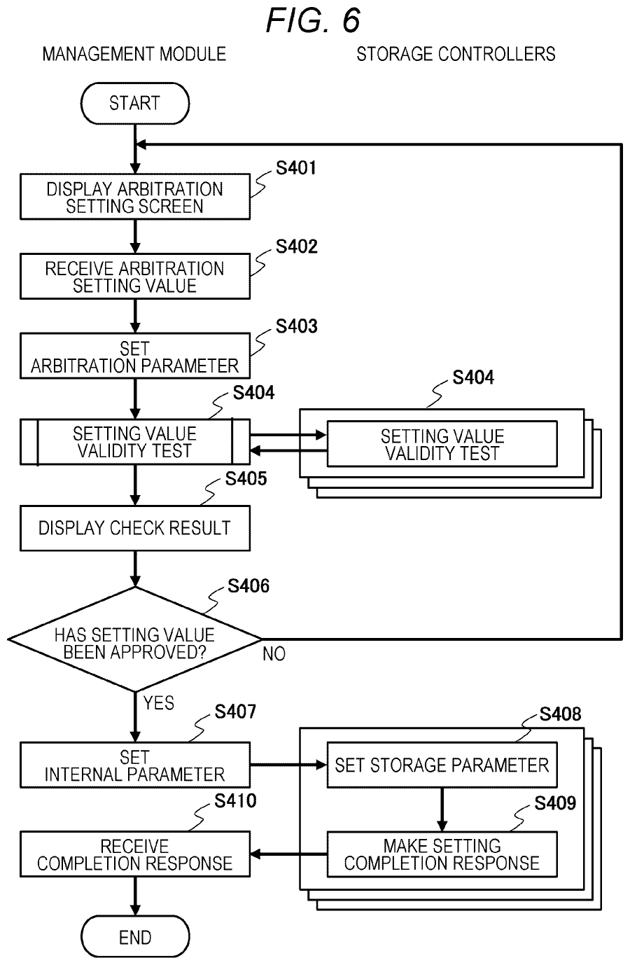

FIG. 6 is a flowchart illustrating an example of arbitration setting processing executed in the primary-side storage systems 100.

For example, the management module 110 displays an arbitration setting screen for the user to input an arbitration setting value, on the display 301 of the management host 300 (step S401). The arbitration setting value is a setting value used for the arbitration processing executed through the arbitration program, in the information processing system.

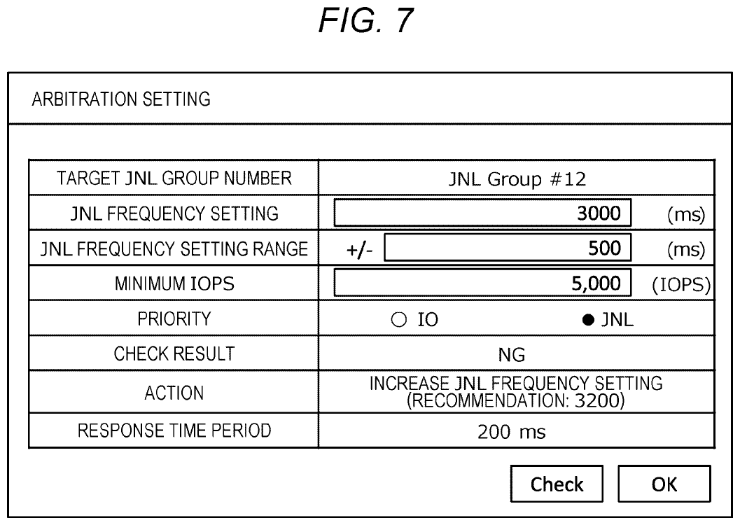

FIG. 7 is a diagram illustrating an example of the arbitration setting screen.

On the arbitration setting screen, display items are displayed such as a target journal group number, a journal frequency setting, a journal frequency setting range, minimum IOPS, priority, a check result, an action, and a response time period.

In the fields of the journal frequency setting, the journal frequency setting range, the minimum IOPS and the priority, respective arbitration setting values set at the moment are displayed, and the user can input and change the arbitration setting values.

In the field of the check result, a result of a setting value validity test to be described later is displayed.

In the field of the action, an action recommended to the user is displayed according to the result of the setting value validity test.

In the field of the response time period, a response time period is displayed, which is a response time period from when the management module 110 transmits test packets to the storage controllers 111 to when the management module 110 receives responses from all the storage controllers 111, in the setting value validity test.

Returning to FIG. 6, the management module 110 receives the arbitration setting value input to the arbitration setting screen by the user (step S402).

Next, the management module 110 sets a parameter of the arbitration setting, on the basis of the received arbitration setting value (step S403). The parameter of the arbitration setting includes, for example, the journal frequency setting, the serial number information transmission frequency setting, or the like.

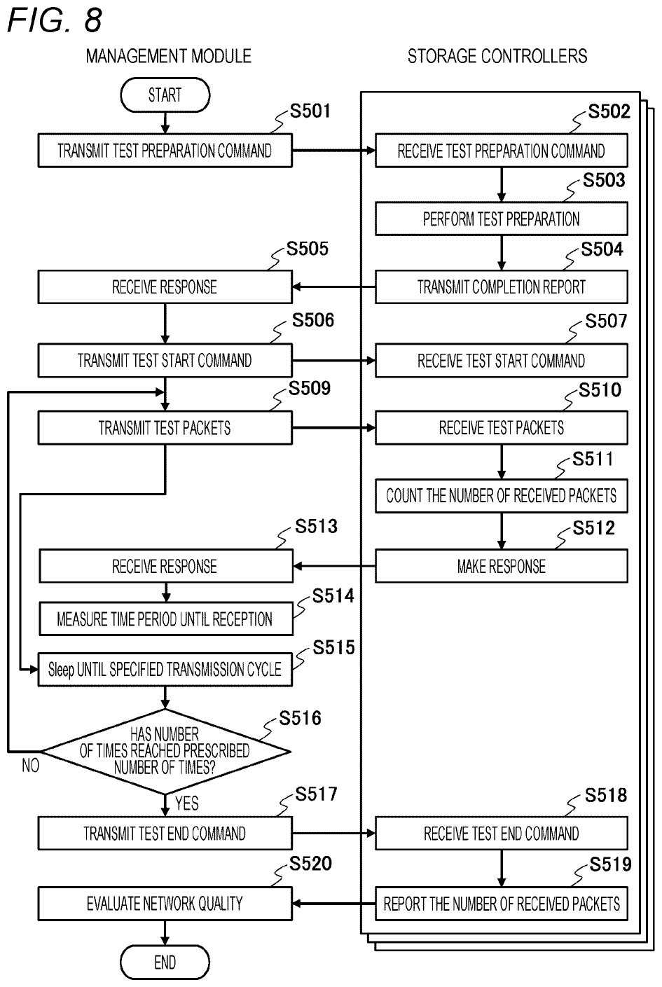

Next, the management module 110 and the storage controller 111 perform a setting value validity test (step S404) to be described later with reference to FIG. 8, and determination is made as to whether the arbitration setting value is valid for network quality between the management module 110 and the storage controller 111.

Next, the management module 110 displays the result of the setting value validity test, received from the storage controller 111, in the field of the check result on the arbitration setting screen (step S405). In addition, when there is an action recommended to the user, the action is displayed in the field of the action on the arbitration setting screen.

Next, the management module 110 determines whether approval for the arbitration setting value by the user has been received (step S406). The approval for the arbitration setting value is performed, for example, by pressing an “OK” button on the arbitration setting screen of FIG. 7.

In a case where the approval for the arbitration setting value has not been received in step S406 (No in step S406), the processing returns to step S401. On the other hand, in a case where the approval for the arbitration setting value has been received by the user in step S406 (Yes in step S406), the processing proceeds to step S407.

In step S407, the management module 110 sets an internal parameter on the basis of the approved arbitration setting value (step S407). The internal parameter includes, for example, the journal frequency setting, the serial number information transmission frequency setting, or the like. In addition, the management module 110 transmits the arbitration setting value to all the storage controllers 111.

Next, each storage controller 111 sets a storage parameter on the basis of the arbitration setting value transmitted from the management module 110 (step S408). The storage parameter is, for example, the packet dequeuing frequency or the like.

Next, when the storage controller 111 completes the setting of the storage parameter, the storage controller 111 transmits a setting completion response to the management module 110 (step S409).

The management module 110 receives the setting completion response transmitted from the storage controller 111 (step S410), and ends this processing.

According to the processing of FIG. 6, it is determined whether the arbitration setting value input by the user is valid for the network quality, and the determination result is displayed. Therefore, the user can change or approve the input arbitration setting value with reference to the determination result.

FIG. 8 is a flowchart illustrating an example of the setting value validity test in step S404 of FIG. 6. In the setting value validity test, test packets are transmitted from the management module 110 to the storage controllers 111 through UDP communication on the basis of the arbitration setting value set with the management module 110, and communication quality of the network is evaluated from results of reception of the test packets in the storage controllers 111.

The management module 110 transmits a test preparation command to the storage controllers 111 of all the primary-side storage systems 100 to be operated (step S501). Each storage controller 111 receives the test preparation command transmitted from the management module 110 (step S502). Next, each storage controller 111 performs test preparation (step S503), and transmits a completion report on the test preparation to the management module 110 (step S504).

Next, when the management module 110 receives the test preparation completion reports from all the storage controllers 111 (step S505), the management module 110 transmits a test start command to the storage controllers 111 of all the primary-side storage systems 100 to be operated (step S506). Each storage controller 111 receives the test start command transmitted from the management module 110 (step S507).

Next, the management module 110 transmits test packets to the storage controllers 111 of all the primary-side storage systems 100 to be operated (step S509). Each storage controller 111 receives the test packets transmitted from the management module 110 (step S510), and counts the number of received test packets (step S511).

At this time, the test packets transmitted from the management module 110 are stored in the UDP packet queue 170, and each storage controller 111 receives the test packets by checking the UDP packet queue 170 at a preset packet dequeuing frequency.

Next, when each storage controller 111 completes the reception of the test packets, the storage controller 111 transmits a response to the management module 110 (step S512). The management module 110 transmits the test packets a prescribed number of times in the setting value validity test, and each storage controller 111 manages a response to the test packet within a prescribed time period.

The management module 110 receives the response from each storage controller 111 (step S513), and the management module 110 measures a response time period from when the management module 110 transmits the test packets to when the management module 110 receives the responses from all the storage controllers 111 (step S514).

Next, the management module 110 sleeps until a transmission cycle of the test packets specified in advance (step S515), and determines whether the number of times of transmission of the test packets has reached a preset, prescribed number of times (step S516). Here, the transmission cycle of the test packets is the journal frequency setting set from the arbitration setting screen by the user in step S402 of FIG. 6.

In a case where the number of times of transmission of the test packets has not reached the preset, prescribed number of times in step S516 (No in step S516), the processing returns to step S509, and the next test packets are transmitted.

On the other hand, in a case where the number of times of transmission of the test packets has reached the preset, prescribed number of times in step S516 (Yes in step S516), the processing proceeds to step S517.

In step S517, the management module 110 transmits a test end command to all the storage controllers 111 (step S517). When each storage controller 111 receives the test end command transmitted from the management module 110 (step S518), the storage controller 111 reports the number of received test packets counted in step S511 to the management module 110 (step S519).

The management module 110 evaluates the network quality, on the basis of the time period from when the management module 110 transmits the test packets to when the management module 110 receives the responses from all the storage controllers 111, measured in step S514, and the number of received test packets reported from each storage controller 111 in step S519 (step S520), and ends this processing.

In the evaluation of the network quality, for example, in a case where the number of packets transmitted by the management module 110 matches the number of packets received by the storage controller 111, the management module 110 determines that the arbitration setting value is valid for the network quality. In this case, “OK” is displayed in the field of the check result on the arbitration setting screen of FIG. 7.

In a case where the number of packets received by the storage controller 111 is smaller than the number of packets transmitted by the management module 110, the management module 110 determines that the network quality is insufficient for the arbitration setting value. In this case, “NG” is displayed in the field of the check result on the arbitration setting screen of FIG. 7, and an indication prompting an action to increase the journal frequency setting is displayed in the field of the action.

Here, a recommendation value for the journal frequency setting is displayed together with the indication prompting the action to increase the journal frequency setting. The recommendation value for the journal frequency setting is calculated by setting the response time period measured in step S514 as an estimated time period from when the freeze instruction is transmitted from the management module 110 to the storage controllers 111 to when all the storage controllers 111 complete freeze processing.

In a case where the estimated time period exceeds a predetermined value, the management module 110 determines that there is an abnormality in a network environment to present the presence of the abnormality to the user, and displays an indication prompting the user to solve the abnormality in the network environment.

In a case where the number of packets received by the storage controller 111 is smaller, by a predetermined value or more, than the number of packets transmitted by the management module 110, the management module 110 determines that there is an abnormality in the network environment. In this case, “NG” is displayed in the field of the check result on the arbitration setting screen of FIG. 7, and an indication prompting an action to solve the abnormality in the network environment is displayed in the field of the action.

In addition, the response time period measured in step S514 is displayed in the field of the response time period on the arbitration setting screen of FIG. 7. As a result, the network quality between the management module 110 and the storage controller 111 can be presented to the user.

According to the processing of FIG. 8, the network quality is evaluated, on the basis of the time period from when the test packets are transmitted to when the responses from all the storage controllers 111 are received, measured in step S514, and the number of received test packets reported from each storage controller 111 in step S519, whereby it can be determined whether the arbitration setting value for arbitration processing executed by the arbitration program is valid for the network quality.

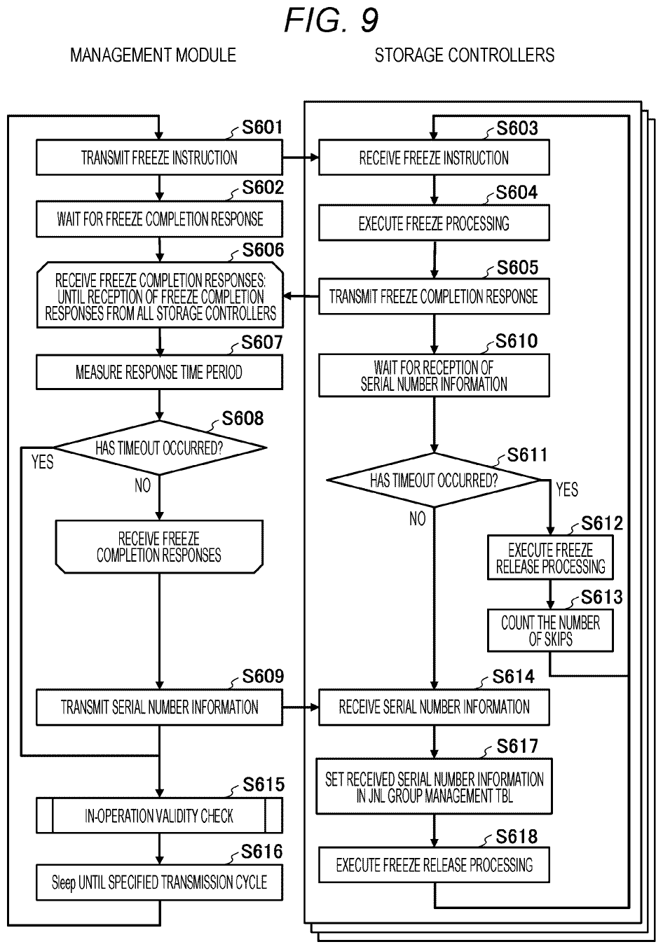

FIG. 9 is a flowchart illustrating an example of arbitration operation monitoring processing.

The management module 110 transmits a freeze instruction to the storage controllers 111 of all the primary-side storage systems 100 to be operated, at a predetermined transmission cycle (step S601). The predetermined transmission cycle is the journal frequency setting set in the arbitration setting processing of FIG. 6. After transmitting the freeze instruction, the management module 110 waits for a freeze completion response from each storage controller 111 (step S602).

When each storage controller 111 receives the freeze instruction transmitted from the management module 110 (step S603), the storage controller 111 executes freeze processing to stop I/O acceptance (step S604).

At this time, the freeze instruction transmitted from the management module 110 is stored in the UDP packet queue 170, and each storage controller 111 receives the freeze instruction by checking the UDP packet queue 170 at a preset packet dequeuing frequency.

Next, each storage controller 111 transmits the freeze completion response to the management module 110 (step S605).

After waiting for the freeze completion response in step S602, the management module 110 performs a freeze completion response reception loop until the management module 110 receives the freeze completion responses from all the storage controllers 111 (step S606).

In the freeze completion response reception loop, when the management module 110 receives the freeze completion response transmitted from the storage controller 111, the management module 110 measures a response time period from when the management module 110 transmits the freeze instruction to when the management module 110 receives the freeze completion response, and the management module 110 stores the measured response time period in the management table 162 of FIG. 5B (step S607).

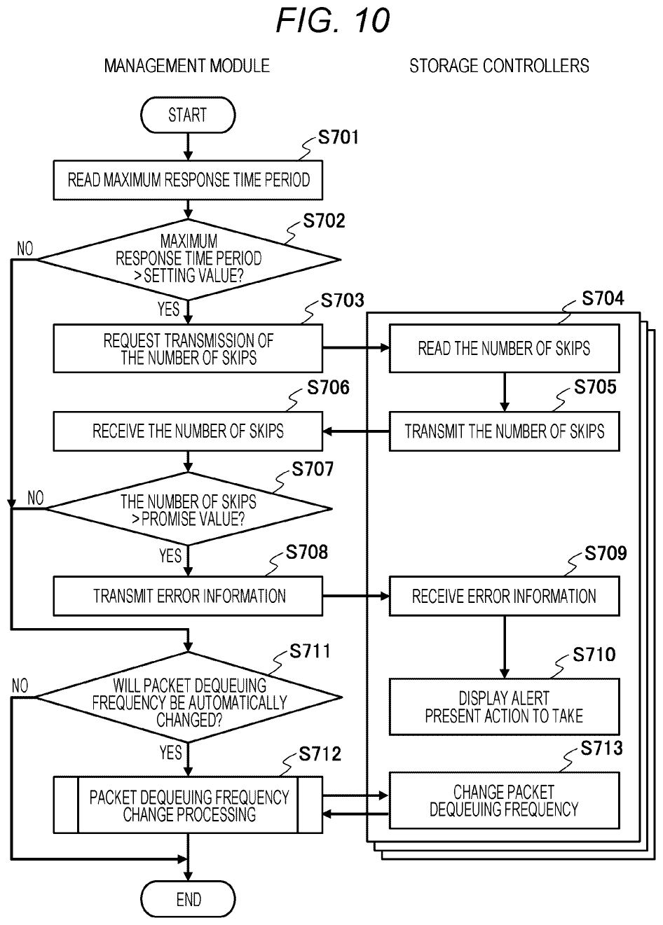

Next, the management module 110 compares the measured response time period with a preset, predetermined time period, and determines whether the predetermined time period has elapsed (step S608). In a case where the predetermined time period has elapsed (Yes in step S608), the management module 110 determines that a timeout has occurred, exits the freeze completion response reception loop, skips transmission of serial number information, and performs an in-operation validity check, described later with reference to FIG. 10, to determine whether the arbitration setting value is valid for the network quality (step S615). In a case where the time period is shorter than the predetermined time period (No in step S608), the freeze completion response reception loop is continuously performed.

In step S608, the management module 110 may measure an elapsed time period after the start of waiting for the freeze completion response in step S602, and determine a timeout on the basis of whether the elapsed time period runs beyond the preset, predetermined time period.

After transmitting the freeze completion response, each storage controller 111 waits for reception of serial number information transmitted from the management module 110 (step S610). After transmitting the freeze completion response, each storage controller 111 determines whether a preset, predetermined time period has elapsed before receiving the serial number information from the management module 110 (step S611). The predetermined time period in step S611 is desirably the same as the predetermined time period set in the management module 110 and used for the timeout determination in step S608.

In Step S611, in a case where the storage controllers 111 each do not receive the serial number information even after the predetermined time period has elapsed (Yes in Step S611), the storage controller 111 determines that the transmission of the serial number information from the management module 110 to the storage controller 111 is skipped. In this case, the storage controllers 111 each determine that a timeout has occurred to release the freeze processing under execution (step S612), and the storage controller 111 counts the number of skips to update the number of skips in the setting information storage table 173 of FIG. 5A (step S613), and resumes the I/O acceptance.

When the management module 110 confirms that the management module 110 has received the freeze completion responses from all the storage controllers 111 within the predetermined time period, the management module 110 ends the freeze completion response reception loop, and transmits the serial number information to all the storage controllers 111 (step S609). In a case where each storage controller 111 receives the serial number information from the management module 110 before the predetermined time period elapses, after transmitting the freeze completion response (No in step S611), the storage controller 111 receives the serial number information transmitted from the management module 110 (step S614), and sets the received serial number information in the journal group management table (step S617). In addition, each storage controller 111 updates the latest serial number information in the setting information storage table 173 of FIG. 5A.

Next, each storage controller 111 executes freeze release processing, and resumes the I/O acceptance (step S618).

On the other hand, after transmitting the serial number information, the management module 110 executes the in-operation validity check of FIG. 10 to be described later, and determines whether the arbitration setting value is valid for the network quality (step S615).

Next, the management module 110 sleeps until a transmission cycle of the freeze instruction specified in advance (step S616), and returns to step S601. Here, the transmission cycle of the freeze instruction is the journal frequency setting set in the arbitration setting processing of FIG. 6.

According to the processing of FIG. 9, the management module 110 measures the response time period until the storage controller 111 responds to the freeze instruction, and monitors the network quality during the operation to check the validity of the arbitration setting value, and thus an appropriate arbitration setting value can be maintained during the arbitration processing.

FIG. 10 is a flowchart illustrating an example of the in-operation validity check in step S615 of FIG. 9.

The management module 110 reads the maximum response time period from the management table 162 of FIG. 5B (step S701). The maximum response time period is a maximum value among the response time periods, measured in step S606 of FIG. 9, from when the management module 110 transmits the freeze instruction to all the storage controllers 111 to when the management module 110 receives the freeze completion responses from the storage controllers 111.

Next, the management module 110 determines whether the maximum response time period exceeds a setting value (step S702). The setting value is set to a value at which no delay occurs when the freeze instruction is transmitted at a predetermined transmission cycle, for example, and is set on the basis of the journal frequency setting set in the arbitration setting processing of FIG. 6.

In step S702, in a case where the maximum response time period does not exceed the setting value (No in step S702), the processing proceeds to step S711.

On the other hand, in a case where the maximum response time period exceeds the setting value in step S702 (Yes in step S702), the management module 110 requests each of all the storage controllers 111 to transmit the number of skips (step S703).

Next, each storage controller 111 reads the number of skips from the setting information storage table 173 of FIG. 5A (step S704), and transmits the number of skips to the management module 110 (step S705).

The management module 110 receives the number of skips transmitted from each storage controller 111 (step S706), and determines whether the number of skips exceeds a preset promise value (step S707). For example, the promise value is set to a value at which the number of skips can be set to zero by a packet dequeuing frequency change processing to be described later in a case where the number of skips is equal to or smaller than the promise value. The promise value may be set by the user or the administrator, and is, for example, zero.

In step S707, in a case where the number of skips exceeds the promise value (Yes in step S707), the management module 110 determines that there is an abnormality in network status, and transmits error information to all the storage controllers 111 (step S708).

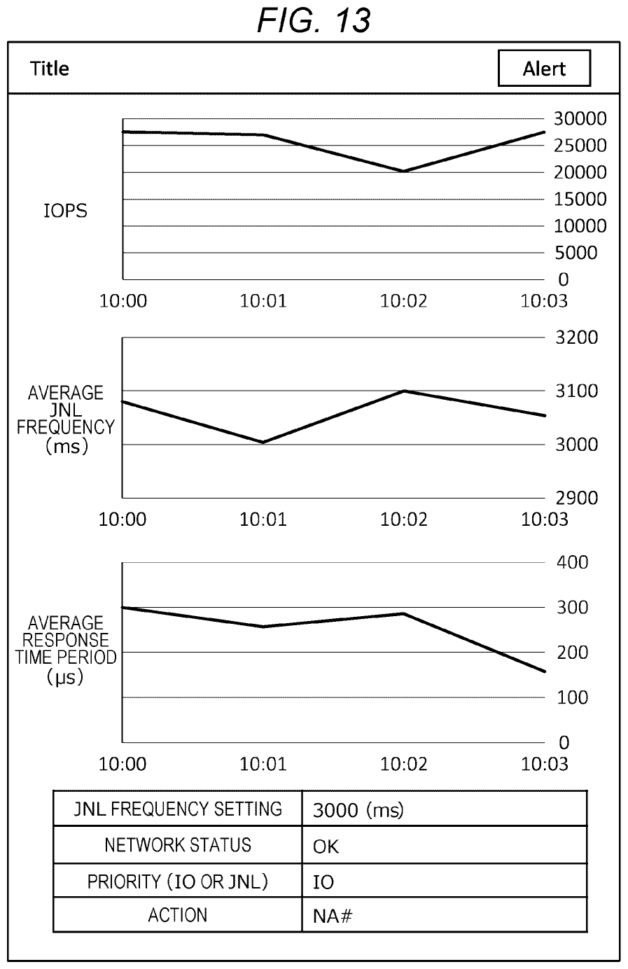

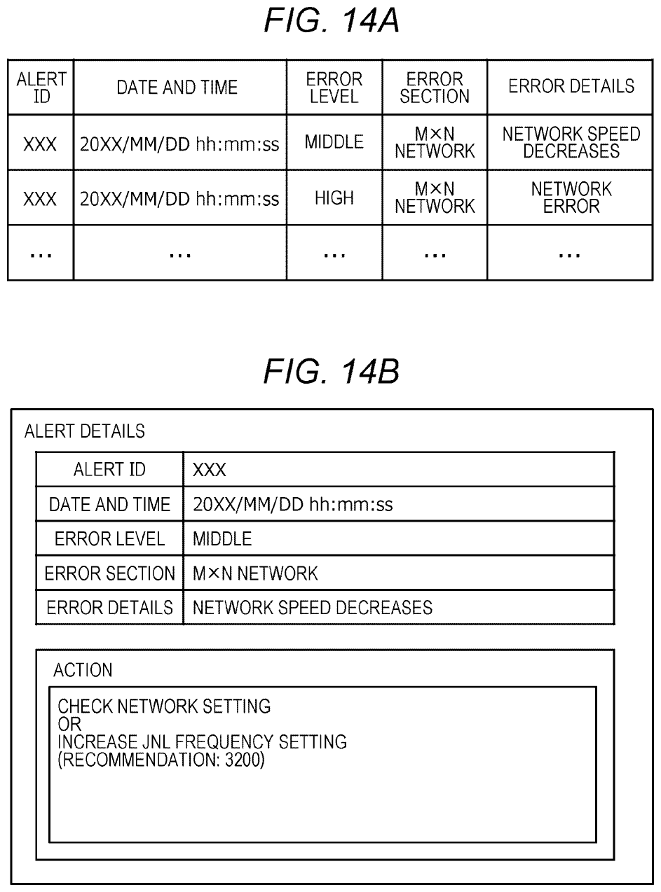

Each storage controller 111 receives the error information transmitted from the management module 110 (step S709), displays an alert on the display 301 of the management host 300, and presents, to the user, an indication prompting the user to take an action (step S710). An example of a display screen displayed in step S710 will be described later with reference to FIGS. 13, and 14A and 14B.

In step S707, in a case where the number of skips is equal to or smaller than the promise value (No in step S707), the management module 110 determines whether to cause the packet dequeuing frequency to be automatically changed (step S711). The packet dequeuing frequency is a frequency at which the CPU 140 of the storage controller 111 checks the UDP packet transmitted from the management module 110 and stored in the UDP packet queue 170. The packet dequeuing frequency is automatically changed when any one of the items “IO” and “JNL” displayed in the field of the priority on the arbitration setting screen of FIG. 7 is selected.

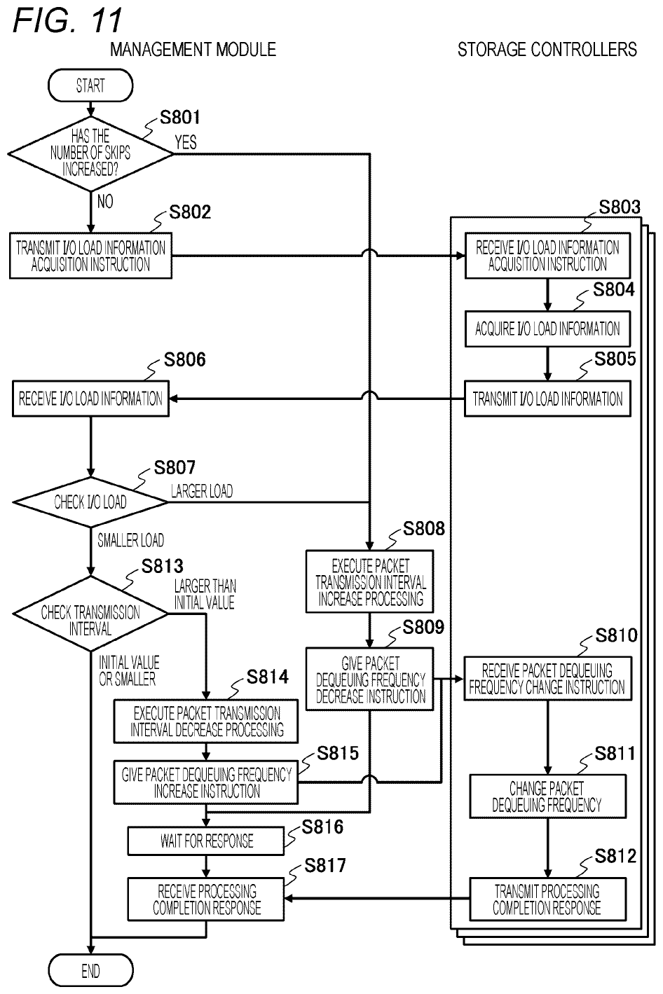

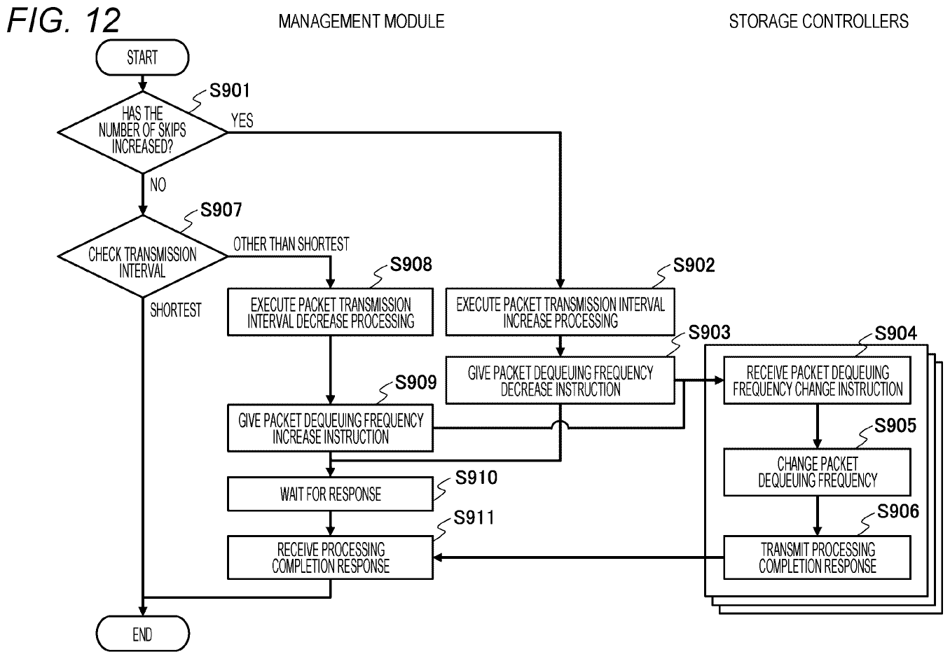

In a case where the packet dequeuing frequency is determined to be automatically changed in step S711, the management module 110 executes a packet dequeuing frequency change processing to be described later with reference to FIG. 11 or 12 (step S712), the storage controller 111 automatically changes the packet dequeuing frequency in accordance with a processing result (step S713), and this processing is ended.

According to the processing of FIG. 10, display of an alert or automatic change of the packet dequeuing frequency is performed in accordance with the number of skips of transmission of the serial number information from the management module 110 to the storage controller 111, and thus an appropriate arbitration setting value can be maintained during the arbitration processing.

FIG. 11 is a flowchart illustrating an example of the packet dequeuing frequency change processing in step S712 of FIG. 10. The packet dequeuing frequency change processing illustrated in FIG. 11 is processing executed in a case where “IO” is selected in the field of the priority on the arbitration setting screen of FIG. 7, that is, a type of packet dequeuing frequency change processing in which priority is given to I/O throughput.

First, the management module 110 refers to information on the number of skips newly received in the in-operation validity check (see step S706 of FIG. 10), and determines whether the number of skips has increased as compared with the number of skips previously received (step S801).

In a case where there is no change in the number of skips, that is, in a case where no new skip has occurred (No in step S801), the management module 110 transmits an I/O load information acquisition instruction to all the storage controllers 111 to be operated (step S802).

When each storage controller 111 receives the I/O load information acquisition instruction (Step S803), the storage controller 111 acquires I/O load information (IOPS) of the CPU 140 of the storage controller 111 (Step S804). Each storage controller 111 transmits the acquired I/O load information to the management module 110 (step S805).

The management module 110 receives the I/O load information transmitted from the storage controllers 111 (Step S806), and determines whether respective I/O loads of the storage controllers 111 each exceed a specified value on the basis of the received I/O load information (Step S807). The specified value is set on the basis of the minimum IOPS set by the user in the arbitration setting processing of FIG. 6.

In step S807, in a case where the I/O load of at least one storage controller 111 exceeds the specified value (“larger load” in step S807), the management module 110 executes processing of increasing a transmission interval of packets (step S808). Here, the transmission interval of packets is the journal frequency setting set from the arbitration setting screen by the user, and an increase in the cycle is the journal frequency setting range set from the arbitration setting screen by the user.

Further, the management module 110 transmits a packet dequeuing frequency decrease instruction to all the storage controllers 111 (step S809), and waits for a response from each storage controller 111 (step S816).

Each storage controller 111 receives the packet dequeuing frequency decrease instruction transmitted from the management module 110 (step S810), and makes a change to decrease the packet dequeuing frequency according to the received packet dequeuing frequency change instruction (step S811). In changing the packet dequeuing frequency, the management module 110 may transmit the packet dequeuing frequency decrease instruction including a value by which the packet dequeuing frequency decreases, and each storage controller 111 may change the packet dequeuing frequency on the basis of this decreasing value. Alternatively, a predetermined decreasing value may be set in advance in each storage controller 111, and when the storage controller 111 receives the packet dequeuing frequency decrease instruction, the storage controller 111 may change the packet dequeuing frequency by this decreasing value.

Next, each storage controller 111 transmits a change completion response on the packet dequeuing frequency to the management module 110 (step S812).

When the management module 110 receives the change completion responses from all the storage controllers 111 (step S817), the management module 110 ends this processing.

Returning to step S807, in a case where the I/O load is equal to or smaller than the specified value in any of the storage controllers 111 (“smaller load” in step S807), the management module 110 further determines whether the transmission interval of packets is equal to an initial value, that is, the journal frequency setting value set from the arbitration setting screen by the user (step S813). In a case where the transmission interval of packets remains at the initial value or is below the initial value (“initial value or smaller” in step S813), the management module 110 ends this processing.

In step S813, in a case where the transmission interval of packets exceeds the initial value (“larger than initial value” in step S813), the management module 110 executes processing of decreasing the transmission interval of packets, that is, processing of decreasing the journal frequency setting by the journal frequency setting range (step S814). Further, the management module 110 transmits a packet dequeuing frequency increase instruction to all the storage controllers 111 (step S815), and waits for a response from each storage controller 111 (step S816).

Each storage controller 111 receives the packet dequeuing frequency increase instruction transmitted from the management module 110 (step S810), and makes a change to increase the packet dequeuing frequency according to the received packet dequeuing frequency change instruction (step S811). In changing the packet dequeuing frequency, the management module 110 may transmit the packet dequeuing frequency increase instruction including a value by which the packet dequeuing frequency increases, and each storage controller 111 may change the packet dequeuing frequency on the basis of this increasing value. Alternatively, a predetermined increasing value may be set in advance in each storage controller 111, and when the storage controller 111 receives the packet dequeuing frequency increase instruction, the storage controller 111 may change the packet dequeuing frequency by this increasing value.

Similarly to the case in which the packet dequeuing frequency is decreased, each storage controller 111 transmits a change completion response on the packet dequeuing frequency to the management module 110 (step S812).

When the management module 110 receives the change completion responses from all the storage controllers 111 (step S817), the management module 110 ends this processing.

Returning to step S801, in a case where there is a change in the number of skips, that is, in a case where a new skip has occurred (Yes in step S801), similarly to the case in which the I/O load of at least one storage controller 111 exceeds the specified value in step S807, the management module 110 executes the processing of increasing the transmission interval of packets (step S808), and transmits the packet dequeuing frequency decrease instruction to all the storage controllers 111 (step S809). Since the operations of the subsequent processing are similar to those described above, the description thereof will be omitted.

According to FIG. 11, the packet dequeuing frequency is changed on the basis of the I/O load information of the CPU 140 of the storage controller 111, and thus an appropriate arbitration setting value can be maintained during the arbitration processing. In particular, in the flows of FIG. 11, the I/O throughput is prioritized. Thus, the management module 110 checks the I/O load, and in a case where the load is large, the transmission interval of packets is increased in the management module 110 in order to decrease the packet dequeuing frequency on the storage side. Correspondingly, the decrease instruction on the packet dequeuing frequency is output to the storage controller 111. In a case where the I/O load returns, the transmission interval of packets is caused to gradually return to a value close to the initial value, and correspondingly, the increase instruction on the packet dequeuing frequency is output. On the other hand, also in a case where the number of skips in the arbitration increases, the management module 110 suppresses an increase in an amount of data to be deleted in restoration after the arbitration failure, in response to delay of the network, by increasing the transmission interval of packets and giving the packet dequeuing frequency decrease instruction.

FIG. 12 is a flowchart illustrating an example of the packet dequeuing frequency change processing in step S712 of FIG. 10. The packet dequeuing frequency change processing illustrated in FIG. 12 is processing executed in a case where “JNL” is selected in the field of the priority on the arbitration setting screen of FIG. 7, that is, a type of packet dequeuing frequency change processing in which priority is given to the arbitration processing.

In the packet dequeuing frequency change processing illustrated in FIG. 11, change in the transmission interval of packets made by the management module 110 and change in the packet dequeuing frequency made by each storage controller 111 are performed, on the basis of the I/O load information received from the storage controllers 111. However, in the packet dequeuing frequency change processing illustrated in FIG. 12, the packet dequeuing frequency change processing is executed without depending on the I/O load information.

First, the management module 110 refers to information on the number of skips newly received in the in-operation validity check (see step S706 of FIG. 10), and determines whether the number of skips has increased as compared with the number of skips previously received (step S901).

In a case where there is no change in the number of skips, that is, in a case where no new skip has occurred (No in step S901), the management module 110 further determines whether the transmission interval of packets is a preset lower limit value (step S907). In a case where the transmission interval of packets is the lower limit value (“shortest” in step S907), the management module 110 ends this processing.

In step S907, in a case where the transmission interval of packets is not the lower limit value (“other than shortest” in step S907), the management module 110 executes processing of decreasing the transmission interval of packets, that is, processing of decreasing the journal frequency setting by the journal frequency setting range (step S908). Further, the management module 110 transmits a packet dequeuing frequency increase instruction to all the storage controllers 111 (step S909), and waits for a response from each storage controller 111 (step S910).

Each storage controller 111 receives the packet dequeuing frequency increase instruction transmitted from the management module 110 (step S904), and makes a change to increase the packet dequeuing frequency according to the received packet dequeuing frequency change instruction (step S905).

Next, each storage controller 111 transmits a change completion response on the packet dequeuing frequency to the management module 110 (step S906).

When the management module 110 receives the change completion responses from all the storage controllers 111 (step S911), the management module 110 ends this processing.

Returning to step S901, in a case where there is a change in the number of skips, that is, in a case where a new skip has occurred (Yes in step S901), the management module 110 executes processing of increasing the transmission interval of packets (step S902). Then, the management module 110 transmits a packet dequeuing frequency decrease instruction to all the storage controllers 111 (step S903), and waits for a response from each storage controller 111 (step S910).

Each storage controller 111 receives the packet dequeuing frequency decrease instruction transmitted from the management module 110 (step S904), and makes a change to decrease the packet dequeuing frequency according to the received packet dequeuing frequency change instruction (step S905).

Similarly to the case in which the packet dequeuing frequency is increased, each storage controller 111 transmits a change completion response on the packet dequeuing frequency to the management module 110 (step S906).

When the management module 110 receives the change completion responses from all the storage controllers 111 (step S911), the management module 110 ends this processing.

According to FIG. 12, the packet dequeuing frequency is changed on the basis of the occurrence of the number of skips in the arbitration, and thus an appropriate arbitration setting value can be maintained during the arbitration processing. In particular, in the flows of FIG. 12, since the arbitration processing is prioritized, the packet dequeuing frequency is changed without checking the I/O load. Specifically, the management module 110 checks the transmission interval of packets, and gradually decreases the transmission interval of packets such that the transmission interval is the shortest (the frequency of transmission is the highest). Correspondingly, the management module 110 executes processing of outputting the increase instruction on the packet dequeuing frequency to the storage controller 111. In a case where the number of skips in the arbitration increases, similarly to the flows of FIG. 11, the management module 110 suppresses an increase in an amount of data to be deleted in restoration after the arbitration failure, in response to delay of the network, by increasing the transmission interval of packets and giving the packet dequeuing frequency decrease instruction.

Next, examples of screens displayed on the display 301 of the management host 300 during the arbitration processing will be described with reference to FIGS. 13, and 14A and 14B.

FIG. 13 is a diagram illustrating an example of an arbitration monitoring screen.

On the arbitration monitoring screen, for example, transitions of values such as the IOPS, the average journal frequency, and the average response time period acquired in the processing of FIGS. 9 to 12 are displayed.

Also on the arbitration monitoring screen, pieces of information such as the journal frequency setting, the network status, the priority on IO or journal, and the action are displayed.

With the arbitration monitoring screen of FIG. 13, the user can check network quality between the management module 110 and each of the storage controllers 111, respective I/O loads of the storage controllers 111, current arbitration setting, and the like.

In a case where the number of skips exceeds the preset promise value in step S707 of FIG. 10, the management module 110 determines that there is an abnormality in the network status, and transmits the error information to the storage controller 111. In step S710, the storage controller 111 displays an alert on the display 301 of the management host 300, and presents, to the user, an indication prompting the user to take an action.

At this time, “NG” is displayed in the field of the network status on the arbitration monitoring screen of FIG. 13, and the action that the user is prompted to take is displayed in the field of the action. In addition, by pressing “Alert” on the arbitration monitoring screen of FIG. 13, an alert display screen of FIG. 14A is displayed.

FIG. 14A is a diagram illustrating an example of the alert display screen.

On the alert display screen, pieces of information such as an alert ID, date and time, an error level, an error section, and error details are displayed. These pieces of information are included in the error information transmitted from the management module 110 to all the storage controllers 111 in step S708 of FIG. 10.

With the alert display screen of FIG. 14A, the user can check the error information.

In addition, when the user selects an error identified by the alert ID, an alert detail display screen of FIG. 14B is displayed.

FIG. 14B is a diagram illustrating an example of the alert detail display screen.

On the alert detail display screen, in addition to the pieces of information such as the alert ID, the date and time, the error level, the error section, and the error details, a user's action recommended for solving the error is presented.

With the alert detail display screen of FIG. 14B, the user can check the action recommended for solving the error.

What is claimed is:

1. An information processing system comprising:
a plurality of primary-side storage systems including respective logical volumes; and
one or more secondary-side storage systems configured to copy data of the respective logical volumes included in the plurality of primary-side storage systems, wherein
each of the plurality of primary-side storage systems includes:
a control unit configured to accept and process an input/output (I/O) command specifying a corresponding one of the logical volumes; and
a management unit configured to transmit, to the control unit, a stop instruction instructing the control unit to stop accepting the I/O command, at a predetermined cycle,
the management unit is configured to transmit, to the control unit, test packets, at a transmission cycle set by a user,
the control unit is configured to receive the test packets transmitted from the management unit, and count a number of received packets, and
the management unit is configured to:
acquire, from the control unit, the number of received packets;
perform evaluating the transmission cycle based on the number of received packets; and
present, to the user, a result of the evaluating.

2. The information processing system according to claim 1, wherein
the management unit is configured to perform comparing a number of transmitted packets that are the test packets transmitted by the management unit, with the number of received packets, and evaluate the transmission cycle based on a result of the comparing.

3. The information processing system according to claim 2, wherein
the management unit is configured to evaluate the transmission cycle as being appropriate in a case where the number of transmitted packets matches the number of received packets.

4. The information processing system according to claim 2, wherein
the management unit is configured to evaluate the transmission cycle as being short in a case where the number of received packets is smaller than the number of transmitted packets.

5. The information processing system according to claim 1, wherein
the control unit is configured to transmit a response to the management unit after the control unit receives the test packets, and
the management unit is configured to:
measure a response time period from when the management unit transmits the test packet to when the management unit receives the response; and
present the response time period to the user.

6. The information processing system according to claim 1, wherein
the management unit is configured to transmit, to the control unit, a freeze instruction, at the transmission cycle set by the user,
the control unit is configured to receive the freeze instruction, at a packet dequeuing frequency having been preset, and transmit, to the management unit, a completion response, after the control unit stops I/O acceptance, and
the management unit is configured to:
receive, from the control unit, the completion response;
measure a response time period from when the management unit transmits, to the control unit, the freeze instruction to when the management unit receives, from the control unit, the completion response; and
cause the packet dequeuing frequency to be changed based on the response time period.

7. The information processing system according to claim 6, wherein
in a case where the management unit receives, from the control unit of each of all the plurality of primary-side storage systems, the completion response within a predetermined time period, the management unit is configured to transmit, to the control unit, serial number information set in a journal, the serial number information being information with which consistency of copy data copied to the one or more secondary-side storage systems is determined, and
in a case where the management unit does not receive, from the control unit of each of all the plurality of primary-side storage systems, the completion response within the predetermined time period, the management unit is configured to perform skipping transmitting the serial number information, and
the management unit is configured to cause the packet dequeuing frequency to be changed based on a number of times of the skipping.

8. The information processing system according to claim 7, wherein
the management unit is configured to cause an alert to be presented to the user in a case where the number of times of the skipping is larger than a predetermined value.

9. The information processing system according to claim 7, wherein
the control unit is configured to count the number of times of the skipping transmitting the serial number information, and transmit, to the management unit, the number of times of the skipping, in a case where the control unit does not receive, from the management unit, the serial number information within a predetermined time period after the control unit transmits the completion response responding to the freeze instruction.

10. The information processing system according to claim 6, wherein
the management unit is configured to:
acquire, from the control unit, I/O load information; and
cause the packet dequeuing frequency to be changed based on the I/O load information.

11. A control method of controlling an information processing system including a plurality of primary-side storage systems, one or more secondary-side storage systems configured to copy data of the plurality of primary-side storage systems, and one or more hosts configured to control input/output (I/O) of the plurality of primary-side storage systems, the control method comprising:
in each of the plurality of primary-side storage systems, including a control unit configured to control I/O, and a management unit configured to transmit, to the control unit, test packets, at a transmission cycle set by a user;
by the control unit, receiving the test packets transmitted from the management unit, and counting a number of received packets; and
by the management unit:
acquiring, from the control unit, the number of received packets;
evaluating the transmission cycle based on the number of received packets; and
presenting, to the user, a result of the evaluating.
